(19) United States
(12) Patent Application Publication
(10) Pub. No.: US 2026/0311152 A1
(43) Pub. Date: Oct. 8, 2026

(54) METHOD, COMPUTER-READABLE MEDIA, CONTROL DEVICE AND FINANCE APPLICATION TERMINAL

(71) Applicant: Diebold Nixdorf Systems GMBH, Paderborn (DE)

(72) Inventor: Chistian Beine, Lichtenau (DE)

(21) Appl. No.: 19/481,614

(22) PCT Filed: May 2, 2024
(86) PCT No.: PCT/EP2024/062065

§ 371 Date: Nov. 5, 2025

(30) Foreign Application Priority Data
May 9, 2023 (DE) 10 2023 112 169.3

(51) Int. Cl. G06Q 20/10

(52) U.S. Cl. CPC G06Q 20/1085

(57) ABSTRACT

A method performed by a processor of a financial application terminal may include: determine, whether one or more properties of a contact-based communication between the financial application terminal and a financial application card fulfill a reference criterion, wherein the communication is in accordance with a authentication protocol to authenticate a user of the financial application terminal; and generate a signal representing a result of the determination.

### CROSS-REFERENCE TO RELATED APPLICATIONS

This application is a National Phase filing of International Application Ser. No. PCT/EP2024/062065, for a METHOD, COMPUTER-READABLE MEDIA, CONTROL DEVICE AND FINANCE APPLICATION TERMINAL, filed May 2, 2024, which claimed priority German patent application 102023112169.3, filed May 9, 2023, both of which are hereby incorporated by reference in their entireties.

### BACKGROUND

### 1. Field

Various aspects relate generally to a method, computer-readable media, a control device, and a finance application terminal.

### 2. Description of Related Prior Art

Generally, various technical standards for a payment card that use embedded microchip technology to authenticate transactions are considered to be safe, and thus, enjoy public confidence. One example is the EMV protocol, which was developed to provide a more secure way of conducting payment transactions by replacing the traditional magnetic stripe cards with a chip-based payment card. “EMV” stands for Europay, Mastercard, and Visa, which are the companies that developed the EMV protocol.

### SUMMARY

According to various embodiments, it was recognized that various technical standards, such as EMV as an example, are vulnerable for an attack, e.g., a man-in-the-middle attack, which renders such technical standards unsafe. For example, a relay attack (see FIG. 7) may be applied in order to access financial assets of a user of the chip-based payment card.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1 illustrates a method according to various aspects in a schematic flow diagram;

FIG. 2 illustrates a communication inspection according to various aspects in a schematic flow diagram;

FIG. 3 illustrates a runtime distribution according to various aspects in schematic diagrams;

FIG. 4 illustrates a consistency inspection according to various aspects in a schematic diagram;

FIG. 5 illustrates an implementation of method in a terminal, according to various aspects in a schematic diagram;

FIG. 6 illustrates a terminal according to various aspects in a schematic diagram;

FIGS. 7 and 8 illustrates each an attack scenario, to which the method according to various aspects may be applied, in a schematic diagram;

FIG. 9 illustrates a communication according to various aspects in a schematic flow diagram.

### DETAILED DESCRIPTION

The following detailed description refers to the accompanying drawings that show, by way of illustration, specific details and aspects in which the disclosure may be practiced. One or more aspects are described in sufficient detail to enable those skilled in the art to practice the disclosure. Other aspects may be utilized and structural, logical, and electrical changes may be made without departing from the scope of the disclosure. The various aspects are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa. Throughout the drawings, it should be noted that like reference numbers are used to depict the same or similar elements, features, and structures.

The present disclosure may include various processes (e.g., methods and functions). In some embodiments, the processes may be performed by hardware components or may be embodied in computer-readable instructions, which may be used to cause a general purpose or special purpose processor or logic circuits programmed with the instructions to perform the processes. Alternatively, the processes may be performed by a combination of hardware and software. According to various aspects, one or more processes performed by one or more processors may, illustratively as counterpart, be realized by code segments stored in the memory, wherein, the code segments cause, if executed by the one or more processors, the one or more processors to perform the processes (e.g., functions and methods). The code segments, e.g., provided as part of the software, may be updated via a (e.g., mobile) network, e.g., on demand.

The term “processor” as, for example, used herein may be understood herein as any kind of entity that allows handling data, signals, as examples. The data, signals, as example, may be handled according to one or more specific functions executed by the processor. A processor may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), as examples, or any combination thereof. Any other kind of implementation of the respective functions, which will be described below in further detail, may also be understood as a processor or logic circuit. It is understood that any two (or more) of the processors or logic circuits detailed herein may be realized as a single entity with equivalent functionality, and conversely that any single processor or logic circuit detailed herein may be realized as two (or more) separate entities with equivalent functionality. It is understood that one or more of the method steps detailed herein may be performed (e.g., realized) by a processor, may by one or more specific functions executed by the processor.

The term “control device” (also referred as to controller) may be understood herein as referring to any kind of a logic implementing entity, which may be implemented by a one or more processors (e.g., including a special purpose circuitry) executing software stored in a memory, firmware, or any combination thereof. Thus, a “control device” may include a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “control device” may, for example, include one or more processors executing software or at least code segments, e.g. any kind of computer program, e.g., a computer program using a virtual machine code such as e.g., Java.

The control device may optionally include a memory, e.g., storing code segments that represent the processes provided by the control device, e.g., the controlling of the one or more operating functions. Additionally or alternatively, the memory may store one or more criterions, rules, one or more reference content (e.g., blacklisted content), and algorithms, as examples, as detailed herein, e.g., implementing methods and/or functions thereof.

As used herein, “memory” may be understood herein as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, as examples, or any combination thereof. Furthermore, it is appreciated that registers, shift registers, processor registers, data buffers, as examples, are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

The term “financial application” (FA), e.g., a banking application, may be understood herein as referring to any application related to (e.g., allowing to manage and/or inspect) financial assets, e.g., related to a financial account (e.g., banking account), such as the balance of a banking account as example. Generally, the FA may be understood as not being limited to account related applications. Thus other examples of the FA may include applications to manage financial assets, which are not linked to an account, such as prepaid applications (e.g., GeldKarte or other prepaid debit card applications) or gift card applications as examples. Analogously, a financial account may be understood as not being limited to accounts provided by a bank. Other examples of the financial account may include brokerage account; retirement account; health savings account; retail customer account; college savings account; trust account; payback account; and the like. Examples of FAs may include: managing (e.g., inspecting and/or modifying) a financial account (e.g., of the user), including, as an example, managing details thereof, such as credentials of the account, balance of the account (also referred to as balance inquiries), financial orders, account activity reports; card management; rewards management; and/or financial transactions (e.g., banking transaction); and/or managing (e.g., inspecting and/or modifying) balance of a prepaid card or gift card. Examples of the financial transactions may include: financial transfer to and/or from a financial (e.g., bank) account (also referred to as transfers), e.g., a payment or a financial transfer from account to account; receiving cash from the user (also referred to as deposits); dispensing cash to the user (also referred to as withdrawals).

The term “financial application terminal” (FA terminal), e.g., being a banking terminal, may be understood herein as referring to any device capable of performing a one or more FAs, e.g., in response to an interaction with a human (also referred to as user of the FA terminal), e.g., in response to being instructed by the user. Examples of the FA terminal may include: an automated teller machine (also referred to as ATM), Point-of-Sale (POS) terminal, kiosk, cash register, Electronic Funds Transfer (EFT) terminal, mobile banking terminal, online banking terminal, parking terminal, and any other type of banking terminal.

An ATM may be understood as a self-service machine that allows a user thereof (in this context also referred to as customer) to perform various financial (e.g., banking) transactions such as withdrawals, deposits, transfers, and balance inquiries. A POS terminal may be understood as a device used by merchants to process debit and credit card transactions from a customer. A kiosk may be understood as a self-service machine that allows a customer to perform banking transactions, such as account inquiries and bill payments. A cash register may be understood as a device used by merchants to record sales and transactions and accept cash payments. An EFT terminal may be understood as a device used by merchants to process electronic payments, such as credit and debit card transactions, and wire transfers. A mobile banking terminal may be understood as a device that enables banking transactions using a mobile phone or tablet. An online banking terminal may include a web-based platform that enables customers to access and manage their bank accounts and perform transactions remotely.

In analogy, the term “financial application card” (FA card) may be understood as (e.g., plastic) card that enables the user (in this context also referred to as cardholder) to access a FA at the FA terminal. Generally, the FA card may be understood as not being limited to cards issued by a financial institution (e.g., a bank) or cards that enables the cardholder to access a financial account. Examples of the FA card may include: a debit card; a credit card; a prepaid card; gift card; payback card; and smart cards of other type. The FA card may include a circuit (also referred to as card circuit); and physical contacts (also referred to as card contacts) coupled with the card circuit to exchange (e.g., with the card interface) data with the card circuit via the physical contacts (also referred to as contact-based data exchange or as contact-based communication). The FA card may include such a card circuit; and an antenna coupled with the card circuit to exchange (e.g., with the card interface) data with the card circuit via the antenna (also referred to as wireless or contact-less data exchange or communication), e.g., based on a radio frequency identification (RFID) technology or more preferably near field communication (NFC) technology.

The card circuit (e.g., provided by an embedded microchip) may implement one or more functions of the financial application card, such as, for example, one or more FAs and/or functions (e.g., cryptographic functions) thereof. Optionally, the card circuit may be configured to store data (also referred to as card data) and/or process data (e.g., received via the card contacts), and/or is programmable. Examples of functions provided by the Optionally card may include: identification, authentication, and financial transfer based on prepaid. The card circuit may include a processor (e.g., a data processing unit) and/or a memory. The Optionally card may optionally include a magnetic stripe that stores data (e.g., including a copy of the card data) and can be read out by a card interface. Optionally, the FA card may include an antenna to exchange (e.g., with the card interface) data with the card circuit via the antenna (also referred to as wireless data exchange or as contact-less data exchange), e.g., based on a radio frequency identification (RFID) technology, more specifically near field communication (NFC) technology. According to various aspects, the FA card is configured as contact card, which allows for contact-based data exchange (via the card contacts) and optionally for wireless data exchange. According to various other aspects, the FA card is configured to allow for contact-less data exchange only.

The card contacts may be configured to be contacted be a card interface. For example, each of the card contacts may include one or more metal contacts. When a FA card is used for a contact-based communication (e.g., transaction) with the FA terminal, the FA card communicates with the FA terminal (e.g., the card interface thereof) through card contacts of the financial application card. When a FA card is used for contactless communication with the FA terminal, the FA card communicates with the FA terminal (e.g., the card interface thereof) through the antenna of the FA card.

Analogously, the card interface may be configured to contact the card contacts, when the financial application card is presented to the card interface, e.g., inserted into the card interface. Therefore, the card interface may include a one or more metal contacts (also referred to as interface contacts) configured to contact the card contacts, when the financial application card is presented to the card interface, e.g., inserted into the card interface. In various examples, the card interface may include a recess (e.g., slot), in which the financial application card can be inserted. The interface contacts may be disposed within the recess.

The term “cash” may be understood herein as referring to any (e.g., physical) medium of financial exchange, for example banknotes and coins. The term “banknote” may be understood herein as referring to any negotiable promissory note (e.g., certificate), e.g., made by a bank or other licensed authority, e.g., payable to the bearer on demand.

The term “predetermined” and/or may be understood herein as indicating one or more of the following properties: invariant, determined in the past, stored (e.g., in computer-readable media), implemented by code segments, read-out from a computer-readable media, being a constraint, being a boundary condition. For example, a predetermined information used in a process (e.g., method) may be invariant for multiple iterations of the process, may be determined before starting the process, stored in computer-readable media, e.g., in the code segments including instructions according to process, and the like. According to various aspects, a predetermined information may be used as a reference, e.g., as reference criterion, reference content, and the like.

According to various aspects, the generation of data and/or exchange (e.g., transmission) of data (also referred to as data exchange or as communication) may be in accordance with a communication protocol (e.g., being predetermined). The data exchange may include sending and/or receiving a message (comprising the data) according to the communication protocol. The communication protocol may implement an agreement, according to which the data between two or more parties is exchanged. In its simplest form, the communication protocol may implement a set of rules that specify the syntax, semantics, and synchronization of the data exchange. Additionally or alternatively, the communication protocol defines the format and structure of the message, the order in which multiple messages are sent and received, the error detection and correction mechanisms, and other aspects of the communication. The communication protocol (e.g., a network protocol) may in principle be chosen according to the needs and may (but need not) be configured according to the OSI (Open System Interconnect) reference model. Any form of protocols may be used in analogy in the respective protocol layers. Examples of communication protocols or parts thereof, to which reference is made herein, include: an authentication protocol, a card-terminal communication protocol (e.g., an EMV protocol). For example, a FA may define a financial application protocol including the authentication protocol and/or the card-terminal communication protocol.

The authentication protocol defines an agreement according to which an authentication of one or more parties is executed. Authentication (also referred to as authentication process) may be understood as process of verifying the identity of a party, e.g., a user, device, or system. Authentication involves the exchange of specific data (also referred to as authentication data) between the parties, such as, for example, credentials, a digital certificate, cryptographically generated data, or biometric data. The credentials may include a username and/or a identifier, such as, for example, a password, a personal identification number (PIN) and/or other personal identification code. The personal identification number (PIN) may include a numerical code as identifier. The authentication protocol may implement a set of rules defining the authentication data, route of data exchange, encryption of the data exchange, type of data exchange, how to verify the authentication data, and the like.

In context to the communication between the FA card and the FA terminal, reference will be made herein to “EMV”, which is understood as exemplary implementation of a card-terminal communication protocol for contact-based or contactless communication. The aspects detailed herein with regard to EMV may analogously apply to other implementations (which do not adhere to EMV) of a card-terminal communication protocol, such as, for example, the “Deutsche Geldkarte.”

The term “EMV” refers to a technical standard for a financial transaction (also referred to as EMV transaction). EMV may be implemented by a FA card (also referred to as EMV card) and the FA terminal (e.g., an ATM), which allows a communication between them in accordance with an respective communication protocol (also referred to as EMV transaction protocol or EMV protocol). EMV stands for “Europay, Mastercard, and Visa,” the three companies that created EMV. The EMV protocol implements a standardized set of communication rules and procedures that enable an EMV card (e.g., payment card), which implements the EMV protocol, to communicate with the FA terminal during a financial transaction in accordance with EMV.

For example, the EMV card may include a processor implementing the EMV protocol (also referred to as EMV processor). The EMV card (e.g., the EMV processor) may be configured to generate a unique (e.g., via a cryptographic process) code for each FA (e.g., financial transaction), making it hard to create counterfeit cards or duplicate card information.

When the EMV card is used for a contact-based communication (e.g., transaction), the EMV card communicates with the FA terminal through the card contacts of the EMV card. The data (e.g., authentication data and/or transaction data) is transferred between the EMV card and the FA terminal in accordance with the EMV protocol and in accordance with the Application Protocol Data Unit (APDU), e.g., the structure thereof, as defined by ISO/IEC 7816-4. APDU specifies the command structure exchanged between the EMV card and the FA terminal during the financial transaction. As such, APDU may be understood as communication protocol underlying the EMV protocol, wherein the EMV protocol defines the content of the data exchanged in accordance with APDU. An APDU message (that is, a message being in accordance with APDU) includes a header, which contains information such as the command code and data length, and a body, which contains the data (e.g., in accordance with the EMV protocol) to be transmitted. APDU is utilized to execute various functions, such as, for example, reading and writing data on the EMV card, performing one or more cryptographic operations, and executing one or more financial application specific commands. The content transferred by the APDUs is defined in the EMV protocol.

Examples of a message in accordance with the APDU (also referred to as APDU message) may include a command (also referred to as ATR command) to provide an “Answer to Reset” (ATR); and/or a command (also referred to as dispense authorization command) related to a request of the user to authorize a dispense cash (e.g., being above a reference value).

ATR is a message sent by the FA card to the FA terminal (e.g., card interface thereof) when it is powered on and/or reset. The ATR message may include information about the capabilities and characteristics of the FA card, including its protocol type, historical bytes, and other details indicating how to establish a communication with the FA card. The ATR command is a command sent from the FA terminal (e.g., card interface thereof) to the FA card to retrieve the ATR. The ATR command is typically sent in accordance with the APDU, and the response from the FA card contains the ATR in the form of an APDU responded by the FA card to the FA terminal (also referred to as response APDU).

The EMV transaction protocol consists of several stages:
Initialization: The FA terminal (e.g., an ATM) sends an initialization command (e.g., ATR command) to the EMV card (e.g., EMV processor) to establish a connection. The EMV card responds with its capabilities and/or security features, e.g., via the ATR.
Application Selection: The FA terminal requests a list of applications implemented by the EMV card, and the EMV card responds with the list of applications.
Card Authentication: The FA terminal verifies the authenticity of the EMV card by performing one or more cryptographic operations with the EMV card. This ensures that the EMV card is genuine and not a counterfeit card (fraudulent copy).
Cardholder Verification: The FA terminal prompts the user (e.g., cardholder) to enter a PIN or sign a receipt to authenticate (e.g., verify the identity of) the user. The verification of the user ensures that the user of EMV card is the legitimate cardholder or a legitimate representative thereof.
Transaction Authorization: The FA terminal sends the transaction data (e.g., based on a request of the user or another input of the user to the FA terminal) to the acquirer of the merchant, typically followed by the Card Scheme and the Issuer of the EMV card (e.g., the bank) for approval. After verification of the transaction data, such as the amount and location, and decides whether to approve or decline the transaction. If approved, the issuer generates a cryptogram, which is sent back to the FA terminal. E.g. this will initiate a dispense if the FA terminal is an
Transaction Completion: The FA terminal generates an authorization response based on the cryptogram and sends the authorization response to the EMV card. In response, the EMV card generates a unique transaction code, which is stored in the memory of the EMV card, and the transaction is complete.

The EMV protocol may, for example, support a two-factor authentication, where the user is requested to provide a PIN or signature to complete a transaction, adding an additional layer of security. Additionally or alternatively, an EMV transaction may be implemented through a secure communication process between the FA terminal and the EMV card (e.g., the EMV processor), which prevents unauthorized access to sensitive cardholder information

As detailed above, the EMV protocol may be understood as exemplary communication protocol.

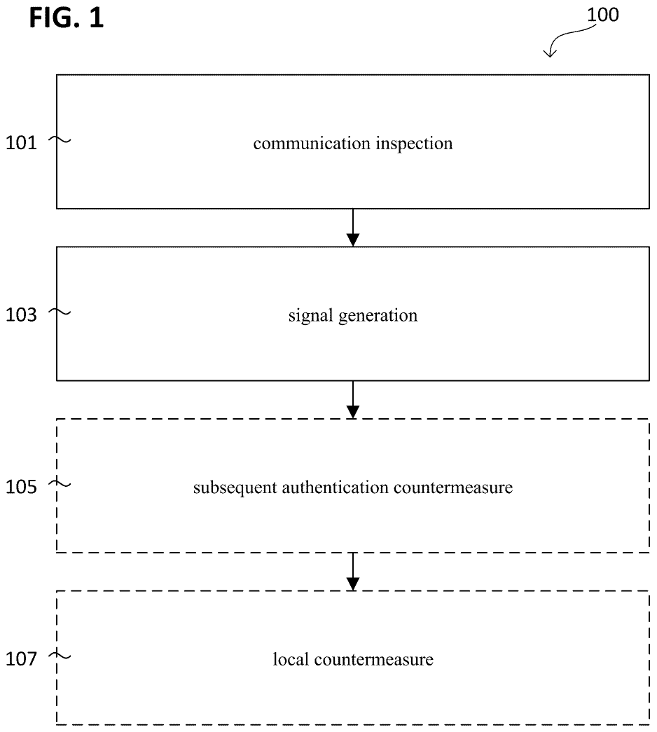

FIG. 1 illustrates a method 100, preferably performed by a processor of a financial application terminal (also referred to as FA terminal), according to various aspects in a schematic flow diagram. The processor of the financial application terminal may be configured to perform method 100.

The method 100 may include, in 101 (also referred to as communication inspection 101), to determine (preferably by the processor), whether one or more properties of a card-terminal communication fulfill a (e.g., stored or otherwise bit-implemented) reference criterion, and in 103 (also referred to as signal generation 103), to generate (preferably by the processor) a signal representing a result of the communication inspection 101. The card-terminal communication may be a communication between the FA terminal (e.g., the card interface thereof) and the FA card and/or may be in accordance with an authentication protocol to authenticate a user of the FA terminal (e.g., via a user authentication device) and/or to authenticate the FA card.

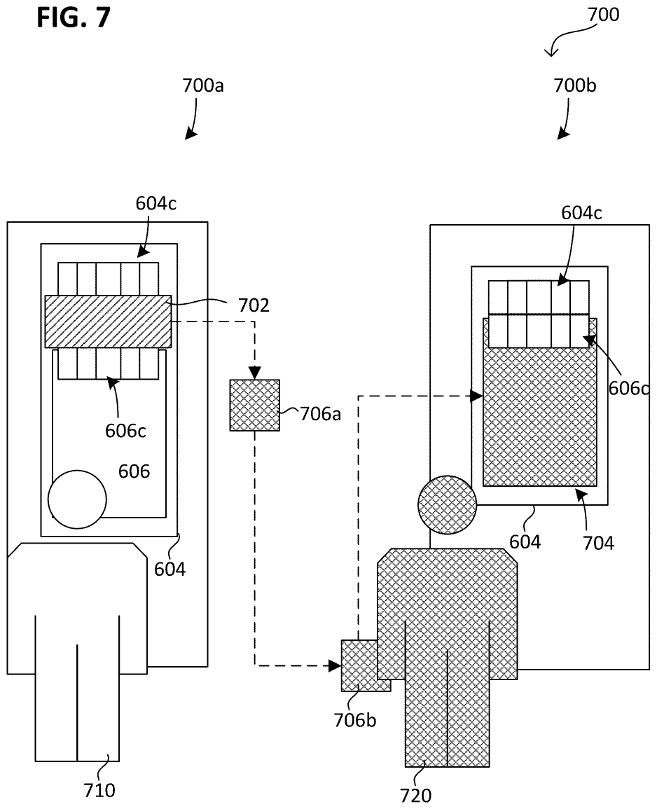

Exemplary implementations of the signal generation 103 may include to generate a first signal (also referred to as approval signal), indicating that the one or more properties fulfill the reference criterion (also referred to as approval), and/or to generate a second signal (also referred to as alarm signal), indicating that the one or more properties did not fulfill the reference criterion (also referred to as alarming). For example, the alarm signal may be generated, when the result of the communication inspection 101 indicates that the card-terminal communication is conducted via a relay, such as a shimmer 702 and/or a relay card 704 as examples (see FIG. 7). The shimmer 702 may be arranged between the FA card (e.g., the card contacts thereof) and the FA terminal (e.g., the interface contacts thereof).

Exemplary implementations of the alarm signal may implement (e.g., trigger) a local countermeasure 107. For example, the alarm signal implementing the local countermeasure 107 may include a message to the FA card and/or to the FA terminal. Additionally or alternatively, the alarm signal implementing the local countermeasure 107 may instruct one or more of the following: reject a request of the user (also referred to as reject command), e.g., reject and abort a FA (e.g., transaction); reject the FA card to the user of the FA terminal; retain (e.g., confiscate) the FA card (also referred to as retain command); repeat the card-terminal communication (also referred to as repeat command). For example, the repeat command may instruct to retry to disrupt replay and may be implemented by the FA terminal (e.g., being an ATM Application feature).

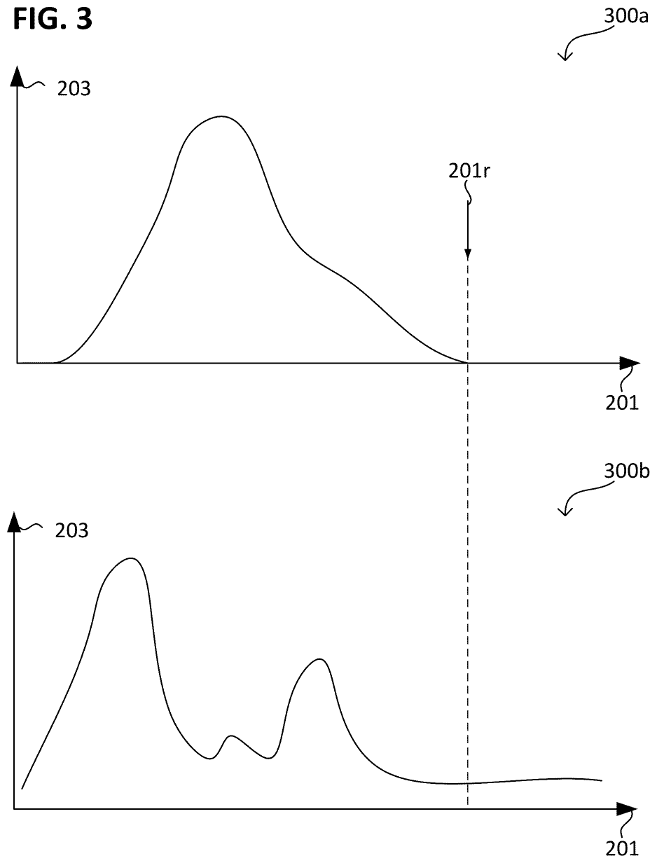

Exemplary implementations of the alarm signal may be related to a subsequent authentication of the user, which occurs within a reference interval (also referred to as reference duration) and/or at a remote terminal 700b (see FIG. 7), and may implement (e.g., trigger) a countermeasure to the subsequent authentication (also referred to as subsequent authentication countermeasure 105). For example, the reference interval (also referred to as reference duration) may start with the card-terminal communication and/or with the signal generation 103. Examples of the reference interval may include 10 seconds(s) or more (in the range of about 10 s to 60 s), e.g., 0.5 minutes or more, e.g., 1 minute or more, e.g., 0.5 hours or more, e.g., 1 hour or more, e.g., 0.5 days or more, e.g., 1 day or more, e.g., 2 day or more, e.g., 1 week or more, e.g., 2 weeks or more, e.g., 5 weeks or more. Additionally or alternatively, the reference interval may be a function of the card-terminal communication and/or the reference runtime 201r (referenced in FIG. 3). For example, the reference interval may last as long as a transaction requested by the user at the FA terminal is completed, and/or be in the range of about 10 s to 60 s. For example, the reference interval may end, when the card-terminal communication is terminated, the reference runtime 201r is exceeded, and/or the FA card is removed from the FA terminal.

As example, the alarm signal implementing the subsequent authentication countermeasure 105 may be directed to a communication server (e.g., banking server) coupled to the FA terminal and/or to a remote terminal 700b (see FIG. 7). Additionally or alternatively, the alarm signal implementing the subsequent authentication countermeasure 105 may include a message to a FA communication network (e.g., banking network) coupled to the FA terminal and/or instruct one or more of the following:
reject the subsequent authentication;
monitor the subsequent authentication;
report the subsequent authentication to a reference recipient (e.g., the user or police), e.g., to start an investigation.

For example, the retain command may include instructing to retract the FA card and start an investigation, which is a very secure countermeasure.

Exemplary implementations of the card-terminal communication may include one or more (e.g., APDU) messages, e.g., being exchanged between the FA terminal (e.g., a card interface thereof) and a FA card. Examples of the card-terminal communication (e.g., the one or more messages) may include: one or more cryptographically secured messages, one or more cryptographic operations (e.g., challenges) and/or one or more commands. A command may be a message including one or more instructions and/or authentication data (e.g., authentication code). For example, an AC command may include authentication code (AC).

Exemplary implementations of the authentication protocol are in accordance with an EMV protocol and/or a contact-based communication protocol. Additionally or alternatively, the card-terminal communication may be contact-based.

Exemplary implementations of the communication inspection 101 may include to determine, whether multiple (e.g., two or three or four) properties (also referred to as communication properties) of the card-terminal communication fulfill the (e.g., stored or otherwise bit-implemented) reference criterion. A higher number of the multiple communication properties reduces the risk of a false positive determination, which may enhance the acceptance and/or reliability of the method 100. For example, a hierarchic inspection of multiple communication properties may provide a reliable defense against relay attacks. For example, the rate of the false positive determination may be below 0.1%.

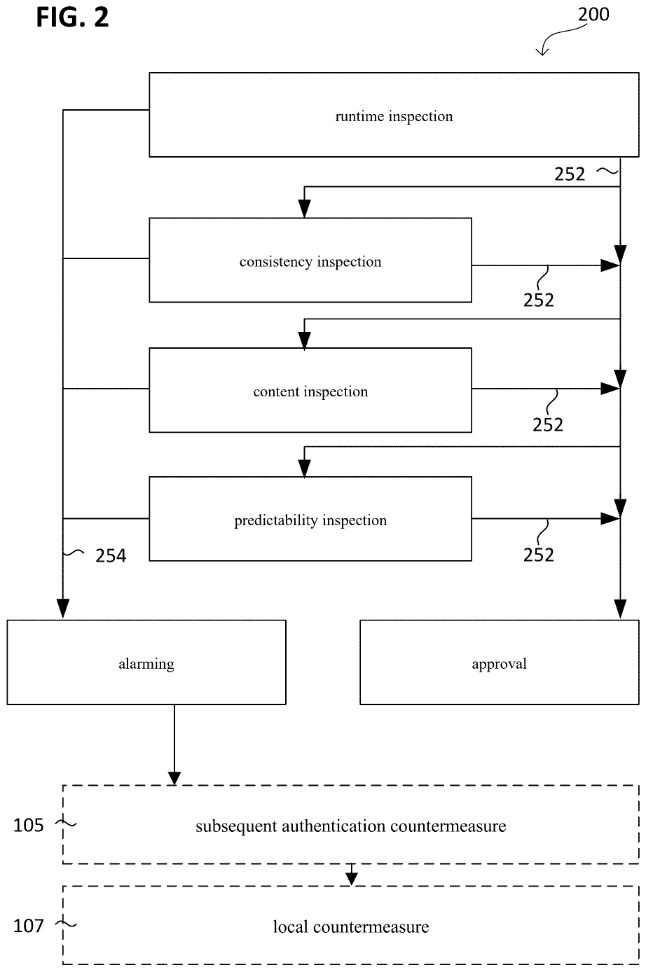

FIG. 2 illustrates the communication inspection 101 according to various aspects in a schematic flow diagram 200, which depicts the cases, in which a communication property fulfills the reference criterion (see line 252) or does not fulfill the reference criterion (see line 254).

For example, the one or more communication properties include a runtime of the card-terminal communication (also referred to as runtime inspection), e.g., a runtime for generating one or more AC commands (also referred to as AC commando runtime). For example, the reference criterion may be fulfilled (see line 252), when the runtime (e.g., AC commando runtime) is in accordance with (e.g., below) a reference runtime. As an example, a shimmer may increase the runtime of a response of the card by 0.1 seconds or more, e.g., by 1 seconds or more.

In an exemplary implementation of the communication inspection 101 (also referred to as hierarchic inspection), the runtime (and/or another communication property) may be implemented as primary communication property (e.g., of multiple communication properties). The hierarchic inspection of method 100 may include determining, whether the primary communication property and one or more supportive communication properties fulfil the reference criterion. Optionally, the hierarchic inspection may include selecting one or more communication properties from a set of reference properties as supportive communication property, e.g., based on a result of determining, whether the primary communication property fulfils the reference criterion. The set of reference properties may include multiple communication properties, e.g., one or more primary communication properties and/or the one or more supportive communication properties.

An exemplary implementation of hierarchic inspection may include, when the runtime is below a first threshold, selecting no supportive communication property and determine the reference criterion as being fulfilled; when the runtime is in the interval between a first threshold and a second threshold, to determine, whether the one or more supportive communication properties fulfil the reference criterion; and when the runtime is above the second threshold, to determine that the reference criterion not fulfilled.

For example, the one or more communication properties include a consistency of the communication (also referred to as consistency inspection), e.g., with data read from a magnetic stripe of the FA card. For example, the reference criterion may be fulfilled (see line 252), when the data provided by the processor (e.g., EMV processor) of the FA card is consistent with the data read from a magnetic stripe of the FA card. The consistency may be used (e.g., selected) as supportive communication property of the multiple communication properties.

For example, the one or more communication properties include a content of the communication (also referred to as content inspection). The content may be used (e.g., selected) as supportive communication property of the multiple communication properties. For example, the reference criterion may be fulfilled (see line 252), when the content of the card-terminal communication differs from one or more reference contents (e.g., blacklisted content). Examples of the reference content may include an ATR command or another APDU message; a command (also referred to as dispense authorization command) indicating a request of the user to dispense cash above a reference value; a cryptographic secured content (e.g., including authentication data); a content pre-calculated by the FA terminal. For example, the reference value may be 1000 Euro or more, e.g., 5000 Euro or more, e.g., 10000 Euro or more.

For example, the one or more communication properties include a predictability of the content of the card-terminal communication (also referred to as predictability inspection). The predictability of the card-terminal communication may be used (e.g., selected) as supportive communication property of the multiple communication properties. For example, the reference criterion may be fulfilled (see line 252), when the content of the card-terminal communication differs from a response of the FA card being pre-calculated by the FA terminal (also referred to as pre-calculated card response). The pre-calculated card response may indicate a response of the FA card, which is implemented by hardcoding (also referred to as hardcoded response).

FIG. 3 illustrates a runtime distribution according to various aspects in schematic diagrams 300a, 300b, in which the amount 203 of commands of the card-terminal communication is depicted as function of the runtime 201 of the respective commands.

Exemplary implementations of the runtime inspection may include to determine (preferably by the processor), whether the runtime 201 of the card-terminal communication (e.g., of more than 10 commands, more than 100 commands or more than 1000 commands), e.g., to and/or from the FA card, is in accordance with (e.g., below) a reference runtime 201r.

In some examples, the reference runtime 201r may indicate an upper limit for an expected (e.g., normal) runtime. For example, a runtime 201 below the reference runtime 201r may be determined as fulfilling the reference criterion (see diagram 300a), otherwise, as not fulfilling the reference criterion (see diagram 300b). Examples of the reference runtime 201r may be about 1300 milliseconds (ms) or less, e.g., 1000 ms or less, e.g., 750 ms or less, e.g., 500 ms or less. In an exemplary implementation of the runtime inspection, the card-terminal communication is determined to not fulfill the reference criterion, when the runtime of the card-terminal communication is more than the reference runtime 201r, e.g., being 1 second.

In other examples, the reference runtime 201r may include one or more statistical values of a (e.g., stored or otherwise bit-implemented) reference runtime distribution, such as, for example, a median, a mean, a variance, a maximum, or the like. For example, a median of the distributed runtime 201 below the median of the reference runtime 201r may be determined as fulfilling the reference criterion.

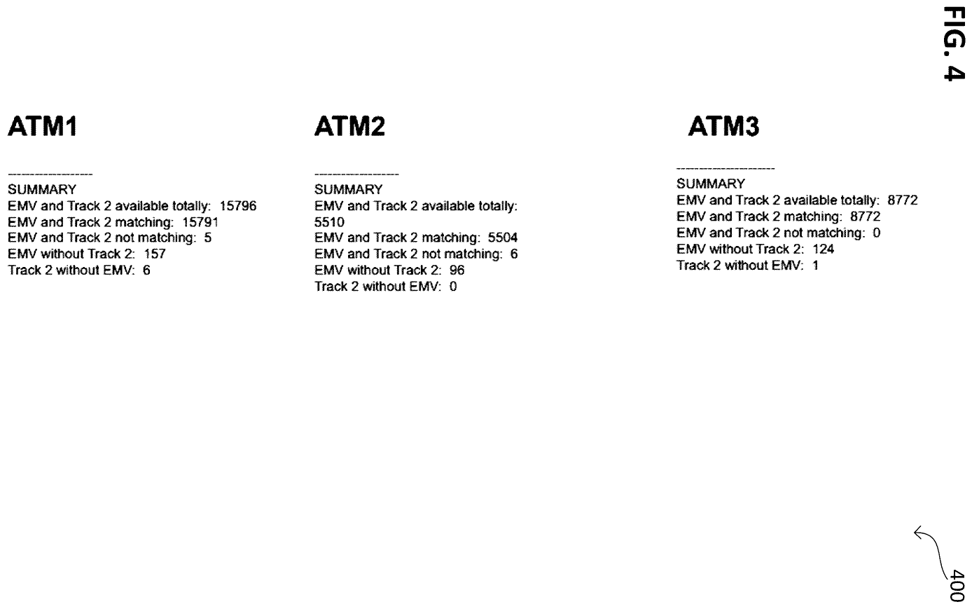

FIG. 4 illustrates the consistency inspection according to various aspects in a schematic diagram 400 for three different FA terminals (referred to as ATM 1, ATM 2 and ATM3).

The combined data from the different FA terminals represent 30461 different legitimate transactions to illustrate a typical consistency of a productive environment. In total 1.3% of the transactions showed a mismatch like it would also be expected in a relay fraud incident. This evaluation shows that a mismatch is a valid, but on its own not sufficient indicator without combination with others. False positive rates would be to high, if only a consistency check would be performed. In addition, the migration to chip only cards in the future will decrease the value of the indicator.

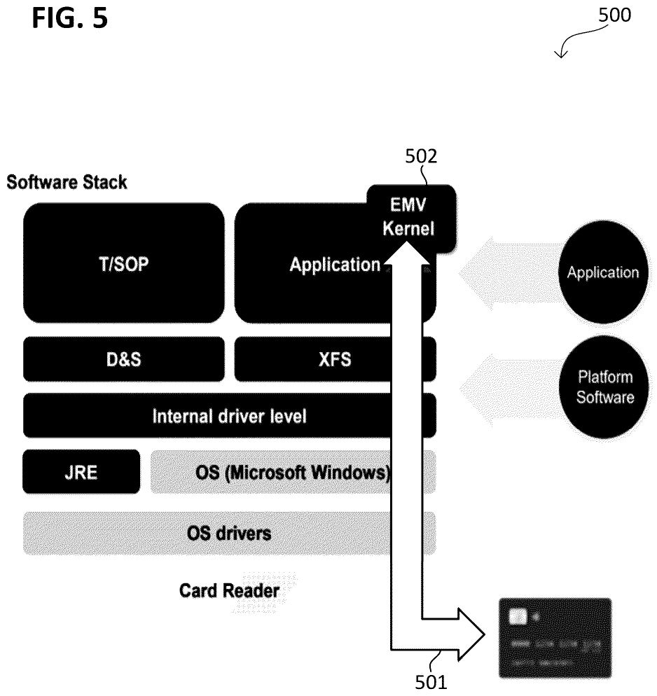

FIG. 5 illustrates an implementation of method 100 in an FA terminal, according to various aspects in a schematic diagram 500. The FA terminal may include an EMV Kernel 502. The card-terminal communication 501 may include an exchange of one or more commands during a transaction between the EMV Kernel and the FA Card. The method 100 may be implemented by the software of the FA terminal, e.g., to detect and prevent a relay attack.

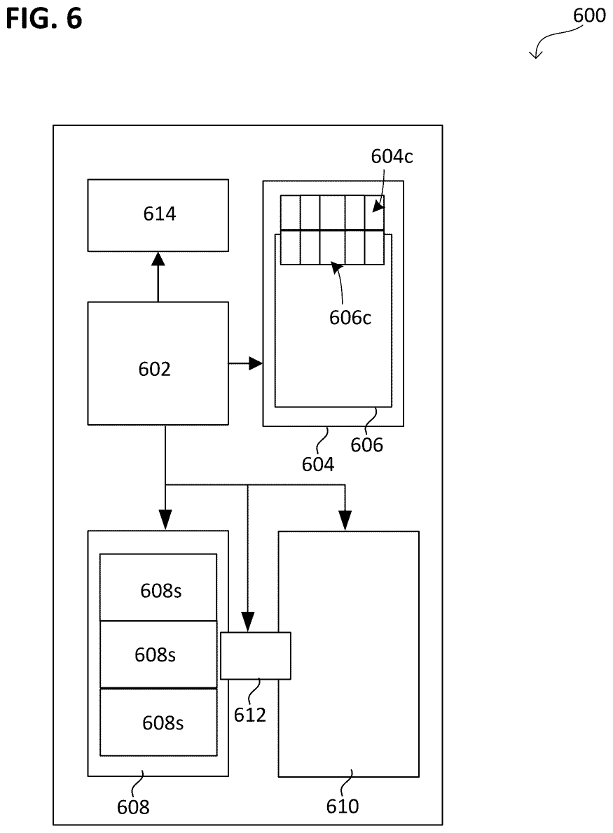

FIG. 6 illustrates an FA terminal 600 (e.g., an ATM) according to various aspects in a schematic diagram. The FA terminal 600 may include a control device 602, e.g., including one or more processors and/or one or more memories. The control device 602 may be configured in accordance with method 100, e.g., by code segments including instructions accordance with method 100 and/or by the architecture of the processor.

Additionally or alternatively, the memory may store a bit string (e.g., code) implementing one or more of the following: one or more reference criterions, one or more reference intervals, one or more reference contents (e.g., blacklisted content, e.g., stored as a blacklist), and/or a list of reference communication properties (e.g., including at least one primary communication property and/or one or more other communication properties) as detailed herein. Generally, a reference criterion may be implemented by an algorithm (e.g., a comparison algorithm), by a value (e.g., threshold), by an interval, by a list of elements (e.g., a blacklist), and may not be understood as being limited to the aspects described herein.

The FA terminal 600 may include a card interface 604 being coupled with the control device 602. The card interface 604 may be configured to exchange data with the FA card 606, e.g., when the FA card 606 is presented (e.g., being in contact with) to the card interface, e.g., inserted into the card interface. For example, the card interface 604 may be configured for a contact-based communication with the FA card 606 (also referred to as contact-based card interface 604). An exemplary implementation of the contact-based card interface 604 may include interface contacts 604c, which contact the card contacts 606c, when the FA card 606 is presented to the card interface, e.g., inserted into a slot of the card interface.

The FA terminal 600 (e.g., when being an ATM) may include a cash storage device 608 configured for storing cash and being coupled with the control device 602. An exemplary implementation of the cash storage device 608 includes a safe, in which one or more cassette receiving slots 608s are arranged. Each cassette receiving slot 608s may be configured to receive a cash storing cassette. The cash storing cassette may include be a container, in which cash is stored, e.g., sorted according to a denomination or another property thereof.

The FA terminal 600 (e.g., when being an ATM) may include a cash exchange device 610, configured to exchange the cash with (e.g., receive cash from or dispense the cash to) the user of the FA terminal 600 and being coupled with the control device 602. An exemplary implementation of the cash exchange device 610 may include a recess (e.g., a slot), through which the cash is exchanged. For example, the cash exchange device 610 may include a door for closing the recess. As detailed above, the card-terminal communication may be based or include on a request of the user to exchange cash via the cash exchange device 610, e.g., a request for deposits or withdrawals via the cash exchange device 610.

The FA terminal 600 (e.g., when being an ATM) may include a cash transfer device 612 (e.g., transport device) configured for transferring the cash between the cash exchange device 610 and the cash storage device 608 and being coupled with the control device 602. As an example, the cash transfer device 612 may include one or more rolls and/or one or more conveyors.

An exemplary implementation of the control device 602 may be configured to control one or more components of the FA terminal (also referred to as FA components), such as, for example, the cash transfer device 612, the cash exchange device 610, the cash storage device 608, a user interface 614 and/or the card interface 604.

The FA terminal 600 (e.g., when being an ATM) may include the user interface 614, preferably comprising a display, to communicate with the user. For example, the user interface may be configured to present (e.g., display) an output to the user and/or receive an input from the user (e.g., a request of the user and/or authentication information). According to various aspects, the card-terminal communication may be based on the input of the user (e.g., a request of the user), e.g., including a request for a financial transfer to and/or from a financial (e.g., bank) account (also referred to as transfers), e.g., a payment or a financial transfer from account to account; for receiving cash from the user (also referred to as deposits); and/or for dispensing cash to the user (also referred to as withdrawals).

An exemplary implementation of the user interface 614 includes a user authentication device configured to receive (e.g., sense) one or more authentication information of the user and provide the authentication data, e.g., to the control device 602. Examples of the authentication information may include: credentials for the account (e.g., including username and/or a identifier, e.g., including username and PIN), biometric information, image data sensed by the authentication device (e.g., of the user or an identification document). The control device may be configured to authenticate the user in accordance with the authentication protocol, e.g., based on the card-terminal communication between the FA card and the card interface.

FIG. 7 illustrates an attack scenario (also referred to as relay attack), to which the method 100 may be applied to reduce the risk of a success of the attack scenario, in a schematic diagram 700, in which a first FA terminal 700a (also referred to as user terminal) and a second FA terminal 700b (also referred to as remote terminal or attacker terminal) are depicted. For example, the user terminal 700a and/or the remote terminal 700b may be an ATM, to which reference is made herein to facilitate the understanding. It may be understood that the attack scenario is not limited to ATMs and that the aspects detailed hereto apply in analogy to other types of FA terminals, such as, for example, parking terminal, car wash terminal, fuel dispensing terminal, and any other type of public terminal.

The equipment of the relay attack includes: one or more internal devices shimmer 702, relay card 704 (e.g., relays) and one or more external devices 706a, 706b (e.g., relays), which may be coupled wirelessly (see dotted lines) with each other. The one or more internal devices shimmer 702, relay card 704 may include the shimmer 702 and/or a manipulated FA card 704 (also referred to as relay card), e.g., being a counterfeit FA card 704. The one or more external devices 706a, 706b may include: a camera, a data transmitter, a cellular mobile device (e.g., smartphone), a mobile router, and the like.

Each of the user terminal 700a and the remote terminal 700b may include the card interface 604. The remote terminal 700b may be manipulated (e.g., by an attacker 720), e.g., by the relay card 704 (also referred to as counterfeit card) presented to the card interface 604 of the remote terminal 700b. For example, the relay card 704 may exchange data with the remote terminal 700b and/or the one or more external devices 706a, 706b during the relay attack.

The shimmer 702 may be understood as a device that is configured sense and/or manipulate (e.g., fully control and/or block) the card-terminal communication between the FA card 606 of the user 710 (also referred to as user card) and the card interface 604 of user terminal 700a, e.g., by being arranged between the card contacts 606c and the interface contact 604c. For example, the shimmer 702 may be configured to implement a man-in-the-middle attack. As an example, the shimmer 702 may be configured to manipulate an FA (e.g., transaction) flow or at least the respective data exchange (also referred to as communication) between the user FA card 606 and the user terminal 700a, e.g., including to force a transmission of credentials (e.g., PIN) as clear text and/or to manipulate a request of the user (e.g., by adding a request for a FA, e.g., transaction) and/or record entering the PIN by a camera operated by the attacker 720 (e.g., fraudster). Said more generally, in some scenarios, any type of input to the user terminal 700a by the user 710 may be sensed by the camera, e.g., by sensing the input of the PIN.

The data skimmed (e.g., sensed) at the user terminal 700a (e.g., sensed by the shimmer 702 and/or a camera) may be transmitted (see dashed line) to the remote terminal 700b, e.g., via the attacker 720, via the one or more external devices 706a, 706b and/or via the relay card 704.

For example, a first external device 706a may be equipped with a SIM card and may forward the data (also referred to as skimmed data) received (e.g., via Bluetooth) from the shimmer 702 and/or from the camera to a second external device 706b, e.g., via a cellular telecommunication system, e.g., via UMTS (Universal Mobile Telecommunications System), LTE (Long Term Evolution), SMS (Short Message Service) or the like. For example, the skimmed data may include credentials (e.g., PIN) of the user, transaction data, one or more APDU commands (e.g., including data provided by the user card 606 to user terminal 700a) and the like. For example, the PIN may be captured when the user enters the PIN to the user terminal 700a and/or may be displayed on a display of the second external device 706b.

The relay card 704 may include an antenna to exchange data with the second external device 706b. The second external device 706b may be equipped with a SIM card and may forward the skimmed data received from the first external device 706a (e.g., via the cellular telecommunication system) to the relay card 704 and/or may be configured to control the relay card 704 based thereon. For example, the second external device 706b may be configured to control the relay card 704, e.g., to control the data provided by the relay card 704 to the remote terminal 700b. Additionally or alternatively, the second external device 706b may be configured to forward the data (also referred to as return data) received (e.g., via Bluetooth) from the relay card 704 to the shimmer 702, e.g., via the first external device 706a, and/or control the shimmer 702 based thereon. For example, the return data may include one or more APDU commands (e.g., including data provided by the remote terminal 700b) and the like. Illustratively, the shimmer 702 may provide data (e.g., to the user terminal 700a and/or to the user card 606) based on or including the return data.

Applying the relay attack may enable to subsequently initiate a FA (e.g., financial transaction) at the remote terminal 700b, such as, for example, dispensing cash to the attacker, or a financial transfer from the account of the user to another account (e.g., of the attacker) and/or which requires an authentication of the user. As effective countermeasure, exemplary implementations of the alarm signal implement the subsequent authentication countermeasure.

As apparent therefrom, the attack scenario reveals two individual card-terminal communications, which are related to (e.g., based on) each other, at which the attack scenario may be detected by the method 100. Said otherwise, aspects of method 100 implemented in a FA terminal may allow the FA terminal to detect the presence of a shimmer at the FA terminal and/or the presence of relay card at the FA terminal. Additionally or alternatively, aspects of method 100 (e.g., the subsequent authentication countermeasure 105) may be implemented by a server (e.g., of the banking host), thereby correlating a transaction initiated by the relay card and the “normal” customer transactions (or other FA at the user terminal 700a), which may occur in the range between 10 seconds to 10 minutes, e.g., 10 seconds to 1 (or 2) minutes.

Regarding the subsequent authentication countermeasure 105 it is noted that modifications of the attack scenario may include to delay the FA at the user terminal 700a until another FA at the remote terminal 700b (e.g., using the relay card) may be completed. Such modification may be detected using the runtime inspection at the user terminal 700a. For example, the delaying the FA transaction may result in a runtime of the card-terminal communication at the user terminal 700a exceeding the reference runtime 201r.

According to various aspects, a manipulation of the card-terminal communication at the user terminal may be detected (by the communication inspection) using the runtime inspection, (e.g., optionally) the content inspection, and/or (e.g., optionally) the predictability inspection. Additionally or alternatively, a manipulation of the card-terminal communication at the remote terminal 700b may be detected (by the communication inspection) using the runtime inspection, (e.g., optionally) the consistency inspection, (e.g., optionally) the content inspection, and/or (e.g., optionally) the predictability inspection.

For example, some data provided by a FA card (e.g., including the relay card 704) to a FA terminal may be based on or include a hardcoded response generated by the FA card (also referred to as hardcoded response). Such hardcoded response may be discarded by the contend inspection. For example, the content inspection may include discarding content of the card-terminal communication, which is a pre-calculated card response. Additionally or alternatively, the content inspection may include to compare the content of the card-terminal communication with a blacklist, and wherein the determination, whether the content of the card-terminal communication fulfills the reference criterion may be based on a result thereof. In contrast, some data provided by a FA card may be variable (also referred to as dynamic response), e.g., being cryptographically secured, cryptographically generated and/or being otherwise unique. The predictability inspection may be configured to determine, whether the content of the card-terminal communication includes a dynamic response (including dynamic content) and/or hardcoded response of the FA card. Thus, the predictability inspection may facilitate the detection of manipulation of the card-terminal communication at the remote terminal 700b by the relay card 704.

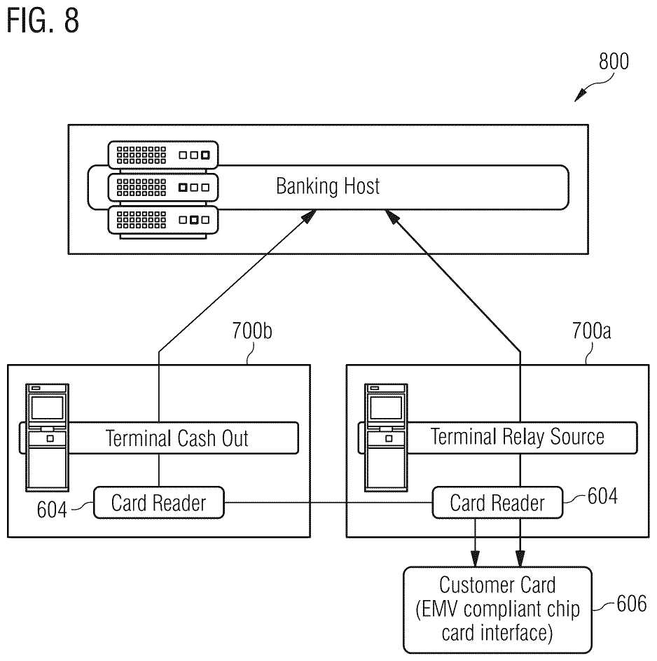

FIG. 8 illustrates the attack scenario according to various aspects, to which method 100 may be applied, in a schematic flow diagram 800, in which the communication with the banking host (e.g., issuer) is depicted.

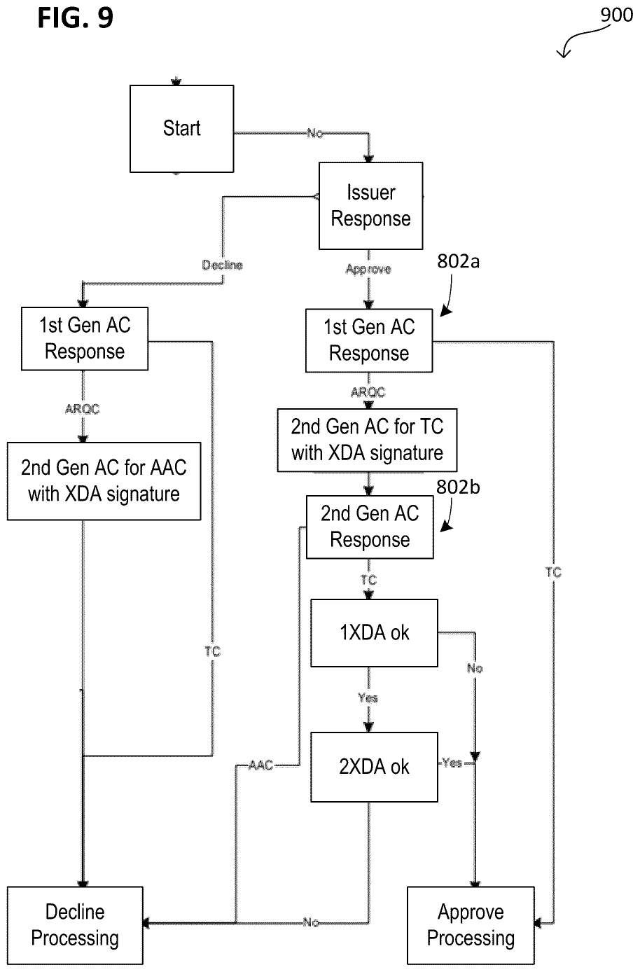

FIG. 9 illustrates a card-terminal communication according to various aspects of method 100 in a schematic flow diagram 900, e.g., XDA (Extended Data Authentication) as an example of many EMV variations, command flow diagram. Schematic flow diagram 900 depicts two commands 802a, 802b including dynamic content, as examples, which differs from the reference content and/or may be supplied to the predictability inspection (e.g., as result, being determined as being not pre-calculated). Each of the two commands 802a, 802b includes a GEN AC (generate AC) commands, which generate the ARQC (Authorization Request Cryptogram).

Additional examples of commands exchanged by the card-terminal communication may include: generate AC command; get challenge command, get processing options command, internal authenticate command, read record command, and verify command. For example, the read record command may include a command that could be executed in advance (thus potentially including pre-calculated content), such that the runtime inspection would not necessarily indicate the presence of a shimmer.

In the following, various examples are provided with reference to the aspects described above.

Example 1 is a method, preferably performed by a processor of a financial application terminal, the method comprising: (e.g., performed by the processor, being configured to) determine, whether one or more properties of a communication (also referred to as card-terminal communication) between the financial application terminal (e.g., a card interface thereof) and a financial application card fulfill a (e.g., stored or otherwise bit-implemented) reference criterion, wherein the communication is in accordance with a authentication protocol to authenticate a user of the financial application terminal (e.g., via a user authentication device) and/or to authenticate the financial application card; (e.g., performed by the processor, being configured to) generate a signal representing (e.g., based on) a result of the determination.

Example 2 is the method of example 1, wherein the communication between the financial application terminal (e.g., a card interface thereof) and the financial application card is contact-based.

Example 3 is the method of example 1 or 2, wherein the authentication protocol is in accordance with (e.g., part of or implemented by) an EMV protocol.

Example 4 is the method of one of examples 1 to 3, wherein the communication is in accordance with the authentication protocol to authenticate the user of the financial application terminal in accordance with a financial application (e.g., financial transaction, e.g., dispensing cash to the user), which is provided by the financial application card and/or which the user has requested (e.g., at the financial application terminal), wherein preferably, the communication is based on a request of the user, with which the user has requested the financial application.

Example 5 is the method of one of examples 1 to 4, wherein the one or more properties of the communication comprise one or more of the following: a runtime of the communication (e.g., a distributed runtime for multiple commands); a content of the communication (e.g., a pre-calculated content and/or a dynamic content); a consistency of the communication (e.g., with data read from a magnetic storage of the financial application card); a direction of the communication (e.g., to or from the FA card); a request of the user (e.g., initiating the communication and/or at the FA terminal), preferably including a request to dispense cash to the user (e.g., exceeding a financial reference value).

Example 6 is the method of example 5, wherein the criterion is fulfilled, when the runtime is in accordance with a (e.g., stored or otherwise bit-implemented) reference runtime, preferably, in accordance with a (e.g., stored or otherwise bit-implemented) reference runtime distribution.

Example 7 is the method of example 5 or 6, wherein the criterion is fulfilled, when the direction of the communication is from the card to the financial application terminal (e.g., a card interface thereof).

Example 8 is the method of one of examples 5 to 7, wherein the criterion is fulfilled, when the data read from the magnetic storage is (e.g., completely) consistent with data provided by the processor (e.g., a chip, e.g., an embedded chip) of the financial application card.

Example 9 is the method of one of examples 5 to 8, wherein the criterion is fulfilled, when the content differs from one or more (e.g., stored or otherwise bit-implemented) reference contents.

Example 10 is the method of example 9, wherein the one or more (e.g., stored or otherwise bit-implemented) reference contents comprise one or more of the following: cryptographic secured content, preferably secured in accordance with the authentication protocol; an authentication code, preferably being in accordance with the authentication protocol; content related to the request of the user to dispense cash to the user, preferably exceeding a financial (e.g., stored or otherwise bit-implemented) reference value of the cash; and/or a hardcoded response (e.g. maintained in a black-list) of the financial application card.

Example 11 is the method of one of examples 1 to 10, wherein the one or more properties indicate that the communication includes a hardcoded response of the card; and/or wherein the one or more properties include a predictability of the communication indicating that the communication includes a hardcoded response of the card; wherein, preferably, the criterion is not fulfilled when the communication includes a hardcoded response (e.g. maintained in a black-list) of the card.

Example 12 is the method of one of examples 1 to 11, further including (e.g., performed by the processor, being configured): to select the one or more properties from a (e.g., stored or otherwise bit-implemented) set of reference properties, preferably based on a runtime of the communication.

Example 13 is the method of one of examples 1 to 12, wherein the signal includes (e.g., when the reference criterion is not fulfilled) an instruction to: retain the card; abort the communication; and/or reject a request of the user relating to the authentication, e.g., initiating the authentication.

Example 14 is the method of one of examples 1 to 13, wherein the signal (e.g., when the reference criterion is not fulfilled) includes an instruction to: reject a subsequent authentication of the user for a reference interval and/or at another terminal; and/or monitor a subsequent authentication of the user within a reference interval and/or at another terminal; and/or report a subsequent authentication of the user to a reference recipient (e.g., the user) for a reference interval and/or at another terminal.

Example 15 is the method of one of examples 1 to 14, further including: (e.g., performed by the processor, being configured) to provide one or more financial applications based on a result of the authentication and/or the signal (e.g., when the criterion is fulfilled); and, preferably, (e.g., performed by the processor, being configured) to negotiate (e.g., with the financial application terminal, e.g., via a card interface thereof), the one or more financial applications with the financial application card.

Example 16 is the method of example 15, wherein the one or more financial applications comprise a financial transfer application and/or are configured for a financial transfer in accordance with a request of the user (e.g., initiating the communication).

Example 17 is a computer program configured to perform the method according to any one of examples 1 to 12, preferably, configured when executed by a processor, to cause the processor to perform the method.

Example 18 is a computer-readable (e.g., non-transitory) medium storing instructions (e.g., implemented by the computer program of example 17), which are configured, when executed by a processor, to cause the processor to perform the method according to any one of examples 1 to 12.

Example 19 is a control device comprising one or more than one processor configured to perform the method of any one of examples 1 to 12, e.g., the processor being configured by the computer-readable (e.g., non-transitory) medium of example 18.

Example 20 is a financial application terminal, comprising: a card interface; a processor (e.g., implemented by the control device of example 19) configured to perform the method of one of examples 1 to 12 and/or configured to: determine, whether one or more properties of a communication between the card interface and a financial application card fulfill a (e.g., stored or otherwise bit-implemented) reference criterion, wherein the communication is in accordance with a authentication protocol to authenticate a user of the financial application terminal (e.g., via a user authentication device); generate a signal representing a result of the determination.

Example 21 is the financial application terminal of example 20, further comprising: a cash storage device configured for storing the cash, wherein the cash storage device comprises preferably a safe and/or one or more cassette receiving slots for receiving a cash storing cassette.

Example 22 is the financial application terminal of example 20 or 21, further comprising: a cash exchange device, configured to exchange cash with (e.g., receive cash from or dispense the cash to) the user of the financial application terminal; wherein, preferably, the communication is based on a request of the user to exchange cash via the cash exchange device.

Example 23 is the financial application terminal of one of examples 20 to 22, further comprising: a cash transfer device (e.g., transport device) configured for transferring the cash between the cash exchange device and the cash storage device.

Example 24 is the financial application terminal of one of examples 20 to 23, further comprising: a user interface, preferably comprising a display, to communicate with the user.

Example 25 is the financial application terminal of example 24, wherein the user interface comprises a user authentication device configured to receive one or more authentication information of the user of the financial application terminal to authenticate the user in accordance with the authentication protocol.

Example 26 is configured according to one of the examples 1 to 25 wherein the card interface includes or is a card reader.

Example 27 is configured according to one of the examples 1 to 26 and further configured according to one of the appended claims.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

1. A method performed by a processor of a financial application terminal, the method comprising:
determine, whether one or more properties of a communication between the financial application terminal and a financial application card fulfill a reference criterion, wherein the communication is in accordance with an authentication protocol to authenticate a user of the financial application terminal; and
generate a signal representing a result of the determination.

2. The method of claim 1, wherein the communication between the financial application terminal and the financial application card is contact-based.

3. The method of claim 1, wherein the authentication protocol is in accordance with an EMV protocol.

4. The method of claim 1, wherein the one or more properties of the communication comprise one or more of the following:
a runtime of the communication;
a content of the communication;
a consistency of the communication with data read from a storage, preferably a magnetic storage, of the financial application card; and
a request of the user initiating the communication, preferably including a request to dispense cash to the user.

5. The method of claim 4, wherein the reference criterion is fulfilled, when the runtime is in accordance with a reference runtime, preferably, in accordance with a reference runtime distribution.

6. The method of claim 4, wherein the reference criterion is fulfilled, when the direction of the communication is from the card to the financial application terminal.

7. The method of claim 4, wherein the reference criterion is fulfilled, when the data read from the storage is consistent with data provided by the processor of the financial application card.

8. The method of claim 4, wherein the reference criterion is fulfilled, when the content differs from one or more reference contents.

9. The method of claim 8, wherein the one or more reference contents comprise one or more of the following:
cryptographic secured content, preferably secured in accordance with the authentication protocol;
an authentication code;
content related to the request of the user to dispense cash to the user; and/or
a hardcoded response of the financial application card.

10. The method of claim 1, further including:
select the one or more properties from a set of reference properties based on a runtime of the communication.

11. The method of claim 1, wherein the signal includes an instruction to:
retain the card;
abort the communication; and/or
reject a request of the user relating to the authentication.

12. The method of claim 1, wherein the signal includes an instruction to:
reject a subsequent authentication of the user for a reference duration and/or at another terminal;
monitor a subsequent authentication of the user within a reference interval and/or at another terminal; and/or
report a subsequent authentication of the user to a reference recipient for a reference duration and/or at another terminal.

13. The method of claim 1, further including:
provide one or more financial applications based on a result of the authentication and on the signal.

14. A computer-readable medium storing instructions, which are configured, when executed by a processor, to cause the processor to perform the method according to claim 1.

15. A control device comprising one or more than one processor configured to perform the method of claim 1.

16. A financial application terminal, comprising:
a processor configured to perform the method of claim 1; and
a card interface.

17. The financial application terminal of claim 16, further comprising:
a cash storage device configured for storing the cash, wherein the cash storage device comprises preferably a safe and/or one or more cassette receiving slots for receiving a cash storing cassette.

18. The financial application terminal of claim 16, further comprising:
a cash exchange device, configured to exchange cash with the user of the financial application terminal.

19. The financial application terminal of claim 16, further comprising:
a cash transfer device configured for transferring the cash between the cash exchange device and the cash storage device.

20. The financial application terminal of claim 16, further comprising:
a user interface, preferably comprising a display, to communicate with the user.

21. The financial application terminal of claim 20, wherein the user interface comprises a user authentication device configured to receive one or more authentication information of the user of the financial application terminal to authenticate the user in accordance with the authentication protocol.
